(19) United States
(12) Patent Application Publication
(10) Pub. No.: US 2006/0178779 A1
(43) Pub. Date: Aug. 10, 2006

(54) Methods optimizing available energy in insulated packaging systems for door-to- door distribution in an unbroken cold chain

(76) Inventor: Bo Gunnar Ahlberg, Dallas, TX (US)

Correspondence Address: GUNNAR AHLBERG, P.O. BOX 820 821, DALLAS, TX, 75382, US

(21) Appl. No.: 10/687,053

(22) Filed: Oct. 17, 2003

(51) Int. Cl. G01M 1/38; G01K 13/00; F25D 3/08; G05B 13/00

(52) U.S. Cl. 700/276; 700/278; 62/371; 62/129

(57) ABSTRACT

An electronic device controlling available energy consumption during time by its communication with another electronic device measuring deviations between set up information and indicative information. The electronic devices, as a part of a physical system, includes but is not limited to control, measure, record, verify and report the operation of the physical system. The physical system create the environment for the packaged product, controls the environment of the packaged product, enable distribution of the packaged product, monitor and log the data from the environment and of the packaged product. The physical system can be defined as a packaging system but may also be cold storage rooms, refrigerators, transportation vessels, machinery and line of production, hospitals or laboratories.

### 1 FIELD OF INVENTION

The invention is generally directed to optimize the use of energy to maintain in transit product (substance) temperature and in particular when used in packaging systems with limited available energy, i.e. no external power source available. Such packaging systems could be refrigerated air cargo containers, refrigerated freight containers or other transportation vessels that carry available energy within its own system.

### 1.1 BACKGROUND OF INVENTION

Temperature sensitive goods constitute a large share of the product inventory of every pharmaceutical company. Unfortunately, each year millions of dollars in temperature sensitive pharmaceuticals are destroyed in transit. In order to maintain quality, all temperature sensitive substances must be continuously stored at the appropriate temperature from the time they are manufactured up until the moment of use. Once substance potency is lost, it cannot be regained or restored, and without proper care, any substance may eventually lose all its potency. If this occurs, the substance will no longer provide any protection against the target disease and is then useless.

The system used for keeping and distributing substances in good condition is called the ‘cold chain’. This consists of a series of storage and transport links, all of which are designed to keep the substance at the correct temperature until it reaches the user. When temperature sensitive substances are distributed special protection in terms of packaging is needed. The Health Care Industry has worked hard to develop its own set of specialized packaging systems. However, even the best packaging system can be defeated by an unexpected deviation in time or ambient temperature. Preserving the value and effectiveness of the substance while meeting the demands of on-time delivery is one of the greatest challenges facing the Health Care Industry today.

The available packaging systems on the market today carry the energy within the same system as were the substance is packed. The control system is designed to measure and regulate the air temperature within the packaging system at one set point. Air temperature within the packaging system fluctuate much more then substance temperature, mainly due to great difference in thermal mass, when ambient in-transit temperature fluctuate due to the environment that the packaging system is exposed to.

When the temperature of the air in the packaging system change, the control system will utilize its energy source to maintain the temperature of the air inside the packaging system, although the temperature of the product has not been affected. More energy then what is actually required will be consumed and, in the end of a distribution, there is no power left to maintain air temperature and the appropriate substance temperature may exceed.

Therefore, it is a need to optimize the use of available energy by allowing the temperature of the substance to fluctuate within given alarms, sacrificing the energy in the thermal mass of the substance, extending the actual time of effective operation of the packaging system. This should be done in conjunction with balancing the actual energy losses in the packaging system.

### 1.1.1 Weaknesses of Current Methods

The control system does not measure the temperature of the substance so that the energy in the substance can be sacrificed within recognized alarms
The air temperature in the packaging system fluctuate significantly more than substance temperature
The packaging system may not record in transit product temperature
The weight of the energy in the packaging system generates additional costs not beneficial for the substance itself
The packaging system is increasingly hazardous for its environment with an increased amount of energy carried within the packaging system should a mechanical failure occur

### 1.2 SUMMARY OF THE INVENTION

The invention is directed to:
Monitor and record in transit substance temperature.
Allow the substance temperature to fluctuate within its alarms and thereby consume less energy within the packaging system.
Optimize the use of energy carried within the packaging system.

The packaging system can in general case be any objects having an electronic device that may optimize the use of available energy. Furthermore, a substance that needs to be transported under temperature control is of special interest, since it is more dependent on the amount of energy that is available. In particular, the present innovation is best suited for packaging systems carried by transportation vessels.

[image]

[image]

[image]

[image]

### 2.2 BRIEF DESCRIPTION OF DRAWINGS

The invention together with further objects and advantages thereof may best be understood by making references to the following description taken together with the accompanying drawings, in which:

FIG. 1 is a schematic illustration of components and embodiment of electronic devices according to the present invention;

FIG. 2 is a schematic illustration describing the process of how to set up temperature alarms;

FIG. 3 is a flowchart describing the process of setting up the control system before its activation;

FIG. 3 is a flowchart describing the process of control system activation, temperature monitoring and logging, display of actual temperature and activation of available energy;

FIG. 4 is a perspective view of a packaging system having an electronic device according to the present invention;

FIG. 5 is a perspective view of a substance loaded in the packaging system. Electronic devices monitor and log substance temperature so that present invention can control and maintain substance temperatures within given alarms.

### 2.3 DETAILED DESCRIPTION OF THE INVENTION

Referring to the drawings in general, it will be understood that the illustrations are for the purpose of describing preferred embodiments of the invention and are not intended to limit the invention to the details thereof.

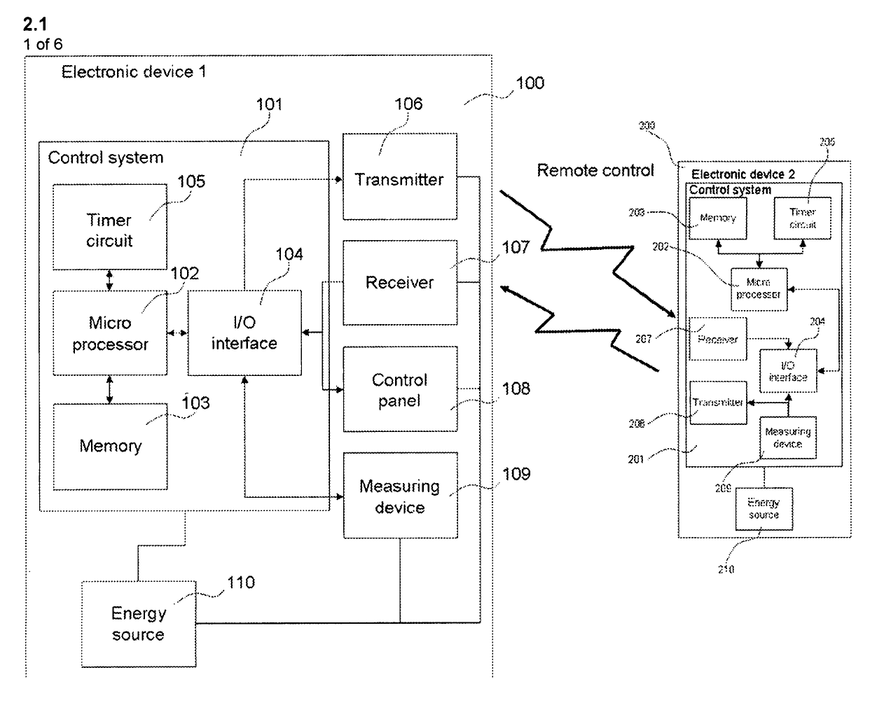

FIG. 1.

FIG. 1 schematically illustrates a typical electronic device 100 according to one embodiment of the present invention. The electronic device 100 or an object to which the electronic device 100 is associated exchange vital functional and operational information for the optimization of energy within the packaging system. The electronic device 100 includes a control system 101 that includes a microprocessor 102 operatively connected with a memory 103, an input/output interface 104 and a timer circuit 105. The microprocessor 102 interfaces with devices outside the control system 101 through the input/output interface 104. If the microprocessor 102 needs to carry out instructions or operations based on time, the microprocessor 102 uses the timer circuit 105.

The electronic device 200 or an object to which the electronic device 200 is associated exchange vital functional and operational information for the optimization of energy within the packaging system. The electronic device 200 includes a control system 201 that includes a microprocessor 202 operatively connected with a memory 203, an input/output interface 204 and a timer circuit 205. The microprocessor 202 interfaces with devices outside the control system 201 through the input/output interface 204. If the microprocessor 202 needs to carry out instructions or operations based on time, the microprocessor 202 uses the timer circuit 205.

The energy source 110 supplies power to the electronic device 100. The energy source 110 is limited and carried within the packaging system. The energy source 110 is connected to the electronic device 100 so that the control system 101 functions can operate as long as energy remains. However, the power to the electronic device 100 may also be supplied by an external energy source. The external energy source may recharge the energy source 110 through the input/output interface 104 when connected to an external energy source. The energy source 110 may also provide power so that the temperature of the substance in the packaging system can remain within its alarms.

The energy source 210 supplies power to the electronic device 200. The energy source 210 is limited and carried within the electronic device 200. The energy source 210 is connected to the electronic device 200 so that the control system 201 functions can operate as long as energy remains.

The electronic device 100 may also contain a transmitter 106. The transmitting device 106 sends signals being interpretable as set up information representing substance temperature alarms, set by the control panel 108, to the electronic device 200. The signals are remotely send to electronic device 200 upon its activation.

The electronic device 200 may also contain a receiver 207. The electronic device 200 can be activated by the control system 101 and is placed in close proximity to the substance that is transported in the packaging system to monitor and log the temperature of the substance.

The electronic device 200 may also contain measuring device 209. The measuring devices 209 monitor temperature of the substance that is transported in the packaging system. The transmitting device 206 transmits temperature related data from the electronic device 200 to the electronic device 100 where the data is processed.

The electronic device 200 may also contain a transmitter 206. The transmitting device 206 sends signals being interpretable as actual substance temperature from the measurement device 209 through the input/output interface 204 to the electronic device 100. The signals are remotely send to electronic device 100.

The electronic device 100 may also contain a receiver 107. The receiving device 107 receives signals being interpretable as actual substance temperature from electronic device 200. The control system 101 shall activate the energy source in close proximity to set substance alarms through the input/output interface 104.

The electronic device 100 may also contain a control panel 108. The control panel device 108 provides access to functions that shall be controlled by the control system 101 through the input/output interface 104. Functions that may be controlled are the operational mode of electronic device 100 and the activation/de-activation mode of electronic device 200.

The electronic device 100 may also contain measuring device 109. The measuring device 109 monitors temperature of the in/out coming air in the cargo area as well as the ambient temperature outside the packaging system. The transmitting device 106 transmits temperature related data from the electronic device 100 to the electronic device 200 where the data is recorded in its memory 203. The control system 101 shall activate the energy source in close proximity to set substance alarms through the input/output interface 104 should electronic device 200 fail to operate in transit.

The electronic device 100 may also contain a memory 103. The memory 103 store operational information related to the functions that may control the mode of electronic device 100.

The electronic device 100 may also contain a microprocessor 102. The microprocessor 102 controls which devices within and/or associated with the electronic device 100 that receive power by controlling the distribution of the energy source 110.

The electronic device 200 may record time based in transit temperature data in its memory 203. It is remotely communicating with electronic device 100 shortly after its activation.

The electronic device 200 may also contain a microprocessor 202. The microprocessor 202 controls which devices within and/or associated with the electronic device 200 that receive power by controlling the distribution of the energy source 210.

The information recorded in the electronic device 200 may be retrieved on a PC computer or similar through the input/output interface 204.

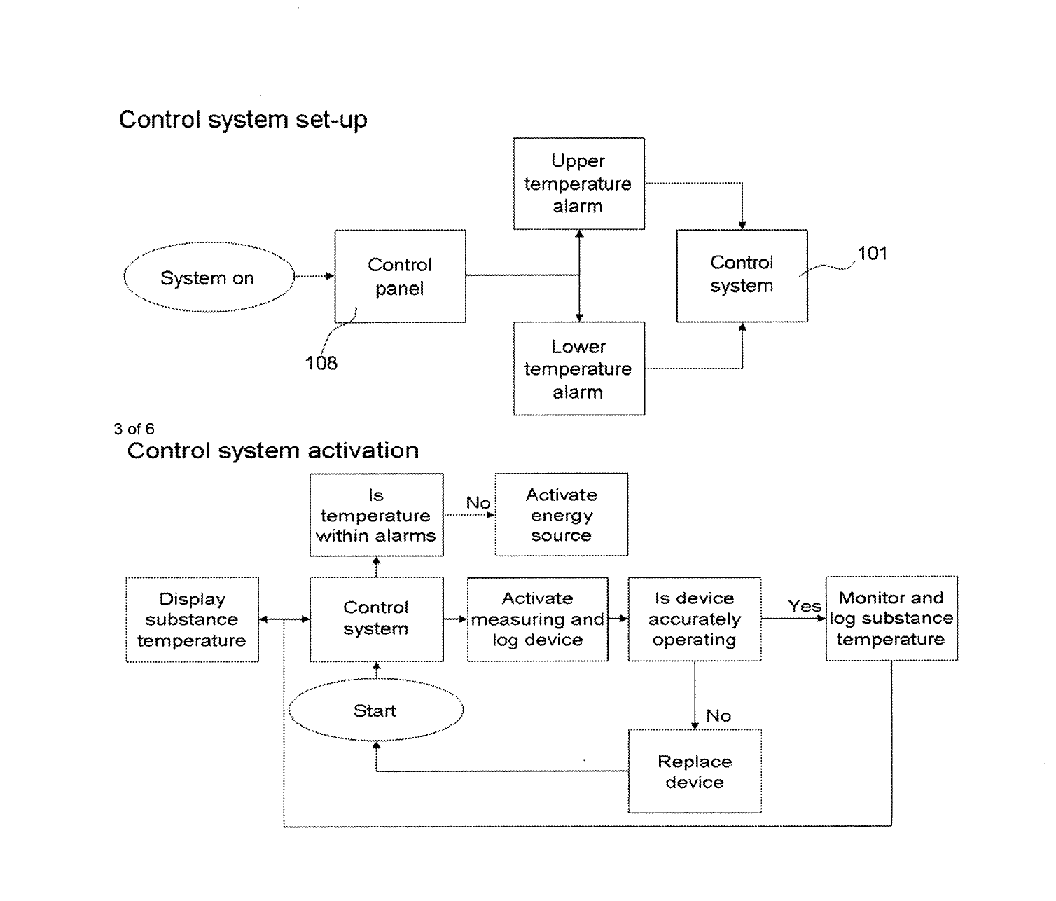

FIG. 2.

FIG. 2 illustrates how to set in-transit temperature alarms for the substance that present innovation is designed to maintain. The electronic device 100 may also contain a system on 108A mode. With the electronic device 100 in mode 108A the upper temperature alarm 108B and the lower temperature alarm 108C may be set by the control panel 108.

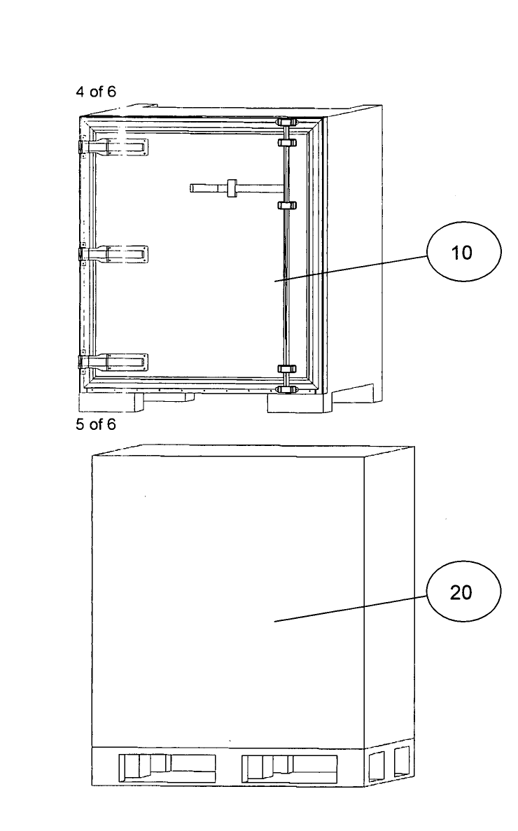

FIG. 3

FIG. 3 illustrates a flow diagram of a typical operation for which the present innovation will operate in order to optimize the use of available energy. The actual operation of an active or passive energy source used to maintain product temperature within a packaging system is well known by anyone skilled in the art. The electronic device 100 may also contain a start 108E mode. When the control system 101 is started through operation of the control panel 108 the control system 101 remotely activates the measuring and log mode 101A in the electronic device 200. The control system 201 verifies its operational functionality 101B automatically and starts to monitor and log substance temperature. Substance temperature 201A is remotely sent to the electronic device 100. The substance temperature 108D may be displayed through the control panel 108. IF the electronic device 200 fail to verify its operational functionality the control system 101 may report a relevant failure mode 101C.

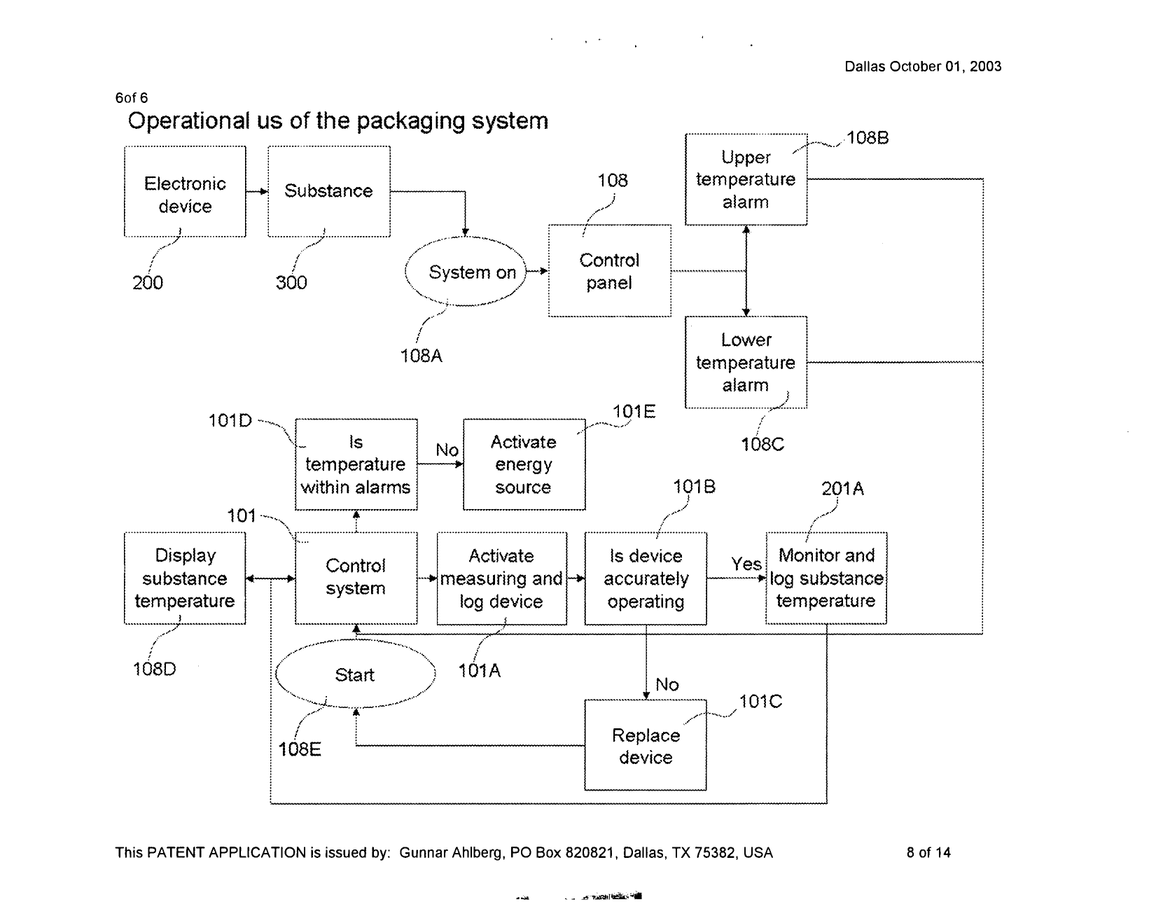

FIG. 4

FIG. 4 illustrates a packaging system for which present innovation is designed to control substances that are temperature sensitive. The packaging system may also contain an electronic device 100. The electronic device 100 in combination with electronic device 200 is designed to optimize the use of available energy.

FIG. 5

FIG. 5 illustrates the substance that will be carried within the packaging system that present innovation may control. The substance is often placed on a pallet for ease in handling. The electronic device 200 may be attached on the substance to monitor and log in transit substance temperature.

FIG. 6

FIG. 6 illustrates the flow of a typical operation for which within the present innovation will be used (note that the substance always must be preconditioned to its optimal temperature prior to transit);
1) Attach electronic devices 200 to the substance
2) Wrap the substance to prevent form toppling or tilting
3) Load the substance into the cargo area and strap it down
4) System in on mode 108A, set temperature alarms 108B and 108C
5) System in start mode 108E, the control system 101 starts to operate
6) Electronic device 200 activated, verification of functionality 101B
7) Control system 101 starts its operation and substance will be maintained within set temperature alarms
8) Door to door distribution, substance temperature 108D may be displayed
9) System stop 108E de-activation of electronic device 200.
10) Unload the substance and collect the electronic device 200
11) Move the substance to cold storage
12) Download and review recorded data

The present innovation is particularly beneficial in connection to packaging systems designed to slow down heat exchange processes. The present innovation may be used in distribution systems requiring a packaging system that needs to carry temperature sensitive substances whereas the energy source is limited and needs to be carefully controlled to last throughout the distribution.

The invention is generally applicable to all areas storing, distributing, operating or handling temperature sensitive substances. Such areas could include cold storage rooms, refrigerators, transportation vessels, machinery of production, line of production, hospitals, laboratories where actual damage to substance may be caused if alarms are exceeded. Furthermore, the invention may optimize the use of energy in mentioned applicable areas as well.

The invention may be used to measure, transmit and control other operations as well such as, shock and vibration, humidity, explosives, accessibility to protected areas, fungus, mould, bacteria's etc.

It will be understood by those skilled in the art of various modifications and changes made to the present innovation without departure from the scope thereof, which is defined by the appendix claim.

1) Packaging system (10, 20), comprising:
An electronic device (100) that in combination with an electronic device (200) optimizes the use of available energy in the packaging system, said electronic device (100) comprising;
control system (101); and
transmitter (106) connected to said control system for sending signals to the electronic device (200) being interpretable as set up information, characterized in that said control system (101) further comprises:
receiver (107) connected to said control system for receiving signals from the electronic device (200) indicative to the proximity of said set up information, characterized in that said control system (101) further comprises:
control panel (108) connected to said control system for the set up of control system information interpretable as set up information, characterized in that said control system (101) further comprises:
measuring device (109) connected to said control system interpretable as external information, characterized in that said control system (101) further comprises:
microprocessor (102) connected to said control system for the processing of set up information, received indicative information and external information, characterized in that said control system (101) further comprises:
energy source (110) connected to said control system distributing energy in proximity of received indicative information and external information.

2) An electronic device (200) for sensing the substance (20) within or in close proximity of the packaging system, said electronic device (200) in turn comprising;
control system (201); and
transmitter (206) connected to said control system for sending signals to the electronic device (100) being interpretable as indicative information, characterized in that said control system (201) further comprises:
receiver (207) connected to said control system for receiving signals from the electronic device (100) indicative being interpretable as set up information, characterized in that said control system (201) further comprises:
measuring device (209) connected to said control system interpretable as indicative information, characterized in that said control system (201) further comprises:
microprocessor (202) connected to said control system for the processing of, set up information, indicative information and external information.

3) Electronic device (100) according to claim 1, characterized in that said control system (101) further comprising a memory (103) for set up information and external information.

4) Electronic device (100) according to claim 1, characterized in that said control system (101) further comprising a timer circuit (105) for time based system information that may be synchronized with control system (201).

5) An electronic device according to claim 1, characterized in that said control system (101) further comprising recording of set up information, indicative information and external information (101A).

6) Electronic device (200) according to claim 2, characterized in that said control system (201) further comprising a memory (203) for set up information, indicative information and external information.

7) Electronic device (200) according to claim 2, characterized in that said control system (201) further comprising a timer circuit (205) for time based system information may be synchronized with control system (101).

8) An electronic device according to claim 2, characterized in that said control system (201) further comprising recording of set up information, indicative information and external information (201A).

9) Method for optimization of available energy is controlled by the electronic device (100), comprising the steps of:
detecting signals from electronic device (200) attached in close proximity to substance (20) indicative to set up information: and detecting signals from measuring device (109) indicative as external information: and verifying proper operation of said available energy.

10) Method according to claim 9, characterized by further steps of monitoring temperature of the substance (20) by a separate electronic device (200) attach in close proximity of the substance and more then one electronic device (200) may be used.

11) Method according to claim 9, characterized by further steps of communication functions between the electronic device (100) and (200) in the exchange of information required for the optimization of available energy.

12) Method according to claim 9, characterized by further steps of monitoring temperature outside and inside the packaging system by measuring devices (109) and (209) indicating energy losses caused by a difference in external information, set up information and indicative information by determining if said indicative information is within set up information and if indicative external information needs to be compensated for, i.e. energy losses through the packaging system (10) itself.
Method for activation of electronic device (200) may be controlled by the electronic device (100), comprising the steps of setting upper and lower temperature alarms (108B and 108C), transmitting set up information and verifying proper operation of electronic device (200).

13) Method for de-activation of electronic device (200) may be controlled by the electronic device (100), comprising the steps of transmitting de-activation information from control system (101) to electronic device (200) and verifying de-activation of electronic device (200).
